(19) United States
(12) Patent Application Publication
(10) Pub. No.: US 2020/0164784 A1
(43) Pub. Date: May 28, 2020

(54) Mobile Store

(71) Applicant: Lime Media Group, Inc., Rowlett, TX (US)

(72) Inventors: Heath HILL, Rowlett, TX (US); Robert COOK, Rowlett, TX (US); Robert FLEMING, Rowlett, TX (US)

(21) Appl. No.: 16/694,773

(22) Filed: Nov. 25, 2019

Related U.S. Application Data
(60) Provisional application No. 62/772,377, filed on Nov. 28, 2018.

(51) Int. Cl. B60P 3/025

(52) U.S. Cl. CPC B60P 3/0255

(57) ABSTRACT

A system and method for a mobile store. The system includes a store box coupled to a vehicle. The store box has at least one cover which is moveable between a retracted and an extended position. In the retracted position the cover hides a display. The store box comprises an interior void which can house inventory. The store box is convertible from a display to a travel position whereby the mobile store can transport to a new location.

### PRIORITY

The present invention claims priority to U.S. Provisional No. 62/772,377 filed Nov. 28, 2018, the entirety of which is hereby incorporated by reference herein.

### BACKGROUND OF THE INVENTION

### Technical Field

The present invention relates to a system for a mobile store.

### Description of Related Art

Traditional brick and mortar retail stores are often struggling. Consumers' purchasing habits have changed and many consumers make purchases online. Consequently, there is a need for a new model for traditional brick and mortar retail stores.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a mobile store in one embodiment;

FIG. 2 is a perspective view of a mobile store in one embodiment;

FIG. 3 is a side perspective view of a store box in one embodiment;

FIG. 4 is a rear perspective view of a store box in one embodiment;

FIG. 5 is a perspective view of a cover frame in one embodiment;

FIG. 6 is a perspective view of a coupler in one embodiment;

FIG. 7 is a side view of a counterbalance in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

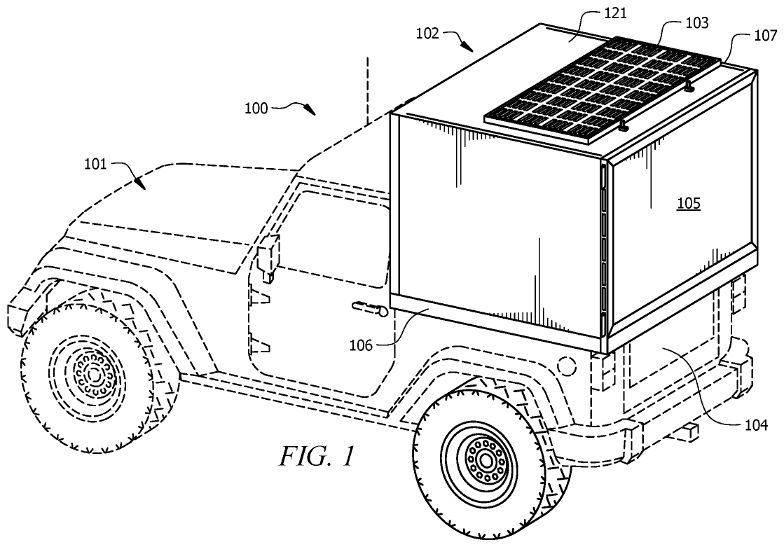

FIG. 1 is a perspective view of a mobile store in one embodiment. As noted, consumer's purchasing habits are changing. Previous brick and mortar stores are facing tough competition as more consumers make purchases on-line. However, there remains a benefit for allowing the consumer to touch and experience a product before making a purchase. Many consumers want to touch and manipulate a product before purchasing. While some of these consumers do not travel to brick and mortar stores, there is an opportunity for these stores to reach out to these consumers with a mobile store.

The mobile store 100 depicts a store which is mobile and which can travel to various locations and reach a variety of potential customers. As shown the retail store comprises a vehicle 101 and a store box 102. The store box 102 can be coupled to the vehicle 101 via any method known in the art.

The vehicle 101 can comprise virtually any vehicle on the market. These can include trucks, Jeeps, vans, sport utility vehicles, etc. Virtually any vehicle can be modified to house and transport a box store 102. As shown the vehicle is the Jeep. The Jeep offers many benefits including the opportunity to store and mount the store box 102 onto the bed portion of the Jeep.

While a store box 102 is shown and described as being a box, this is for illustrative purposes only and should not be deemed limiting. The store box 102 can comprise virtually any shape. It can be square, rectangular, cylindrical, etc.

As shown the store box 102 is located behind the cab of the vehicle 101. This does not inhibit the driver's view while driving the vehicle 101.

The store box 102 is depicted as being behind and downstream of the cab of the vehicle. As used herein, upstream and downstream refer to relative locations on the mobile store 100. Items closer to the front of the vehicle are referred to as being upstream, whereas items further from the front of the vehicle are referred to as being downstream.

The store box 102 is depicted as having four sides and a top. Visible in FIG. 1 is a rear side 105, the driver's side 106, and the top side 121. The passenger's side 107 is opposite the driver's side 106, and is not visible in FIG. 1. Also not shown is the front side. In one embodiment the front side, or any side, can comprise a sign or display which advertises the store. In one embodiment the sign, like the covers 108, can be raised or lowered between an extended and retracted position.

As depicted, a power supply 103 is located on the top side 121. A power supply 103 can comprise virtually any traditional power supply including batteries, connecting to the power grid, solar panels, etc. As shown, the power supply 103 comprises solar panels. This is for illustrative purposes only and should not be deemed limiting.

FIG. 1 shows the store box 102 in the travel position whereby the covers 108 are in their retracted position. In the travel position, the store box 102 is ready for travel in that all items are safety stored and the store box 102 is ready for the wind and air associated with driving down a highway, for example. In one embodiment the system includes a lock which locks the covers in their retracted position. In one embodiment the locking system comprises an electrically actuated locks. Locks increase safety by preventing the covers 108 from undesirably moving to the extended position while in transport.

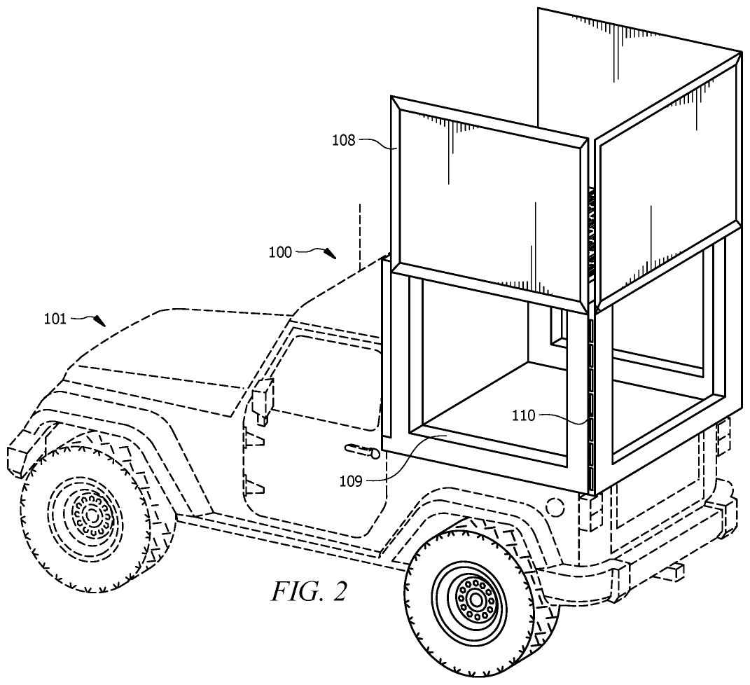

FIG. 2 is a perspective view of a mobile store in one embodiment. As shown, the mobile store is in the display position. In the display position one or more covers 108 are in their extended position. As shown the extended position comprises the covers 108 sliding upward to reveal the contents behind the cover 108. As depicted, there are three covers 108 which have been moved to their extended positions. In this position, the underneath contents can be seen, whether that is a display 109 or an opening into the void.

In one embodiment a display 109 is located behind the cover, and the display 109 becomes visible when the cover is in an extended position. The display 109 can comprise a static display such as a sign. In other embodiments, however, the display 109 comprises a dynamic display which moves and changes. One example of a dynamic display includes a television screen or other monitor, iPad, etc. The display is an opportunity for the consumer to see, hear, learn, and/or experience a product or service being sold. The cover 108 protects the display 109 when in the travel position. The cover 108 can also comprise a display or advertisement providing information about the mobile store 100.

In one embodiment the mobile store 100 comprises three displays 109. In one embodiment the three displays 109 are covered by a removeable cover 108. As shown the driver's side 106, the passenger's side 107, and the rear side 105 each comprise a display 109 and an associated cover 108.

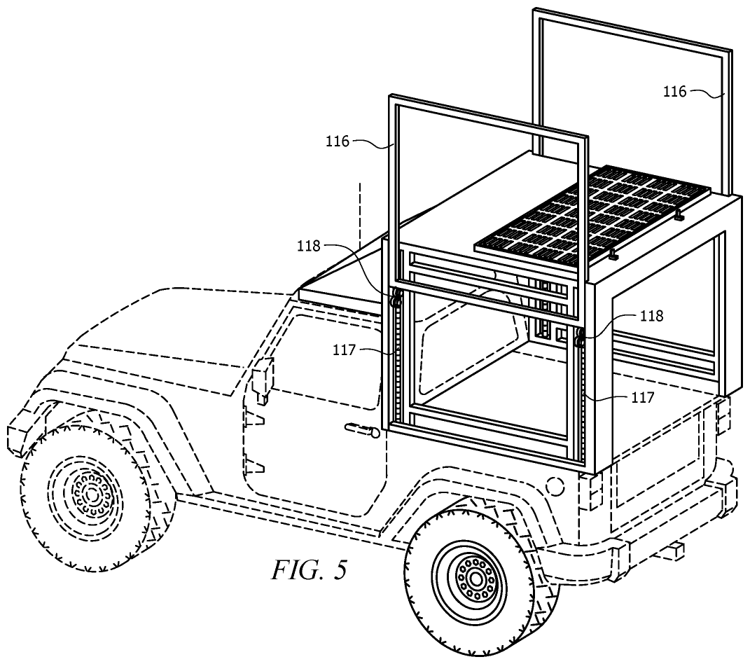

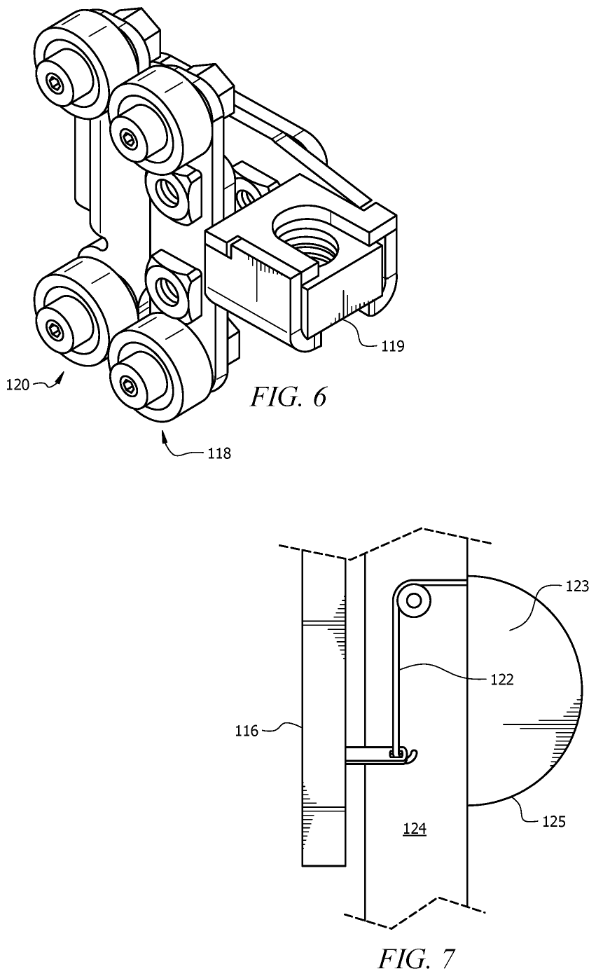

As shown in FIG. 2, the cover 108 extends to an extended position to show the display 109. This can be accomplished via any method or device known in the art. One embodiment utilizing a coupler will be described in more detail later below in reference to FIGS. 5 and 6. Another embodiment using a counterbalance will be discussed in reference to FIG. 7.

In one embodiment the cover 108 is automated so that the cover can extend or retract mechanically. Thus, the user can retract the cover 108 for travel and then extend for a display position by simply pressing a button or otherwise instructing the automation to slide the cover 108. In one embodiment a single motor controls the automation of each cover 108, whereas in other embodiments each cover has its own corresponding cover.

As shown, the rear side 105 is connected via a hinge 110. This allows the rear side to swing open about the hinge 110. This allows a user, or customer, to retrieve items from the store box 102. While one embodiment has been described wherein the rear side pivots about the hinge 110, this is for illustrative purposes only and should not be deemed limiting. In other embodiments, for example, rear door can rotate vertically about a fixed item. Further, while only the rear side 105 is depicted as having a hinge 110, in other embodiments more than one side will have a hinge. In some embodiments the rear side 105 comprises a hinge 110 because it coincides with a tail gate 104, discussed in more detail below. Thus, both the tailgate 104 and the rear side 105, in such embodiments, can be hinged open to reveal the store contents. As noted, other sides can also open relative to a hinge 110.

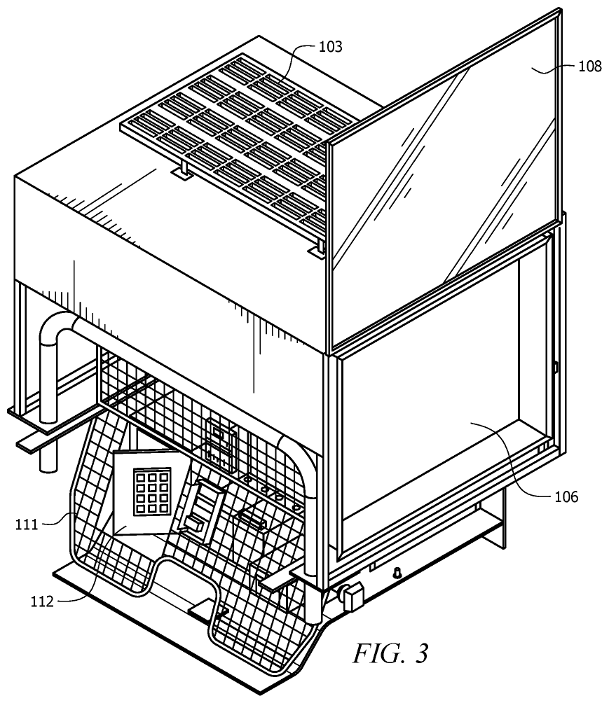

FIG. 3 is a side perspective view of a store box in one embodiment. As shown, the driver's side 106 has a display and a cover 108 in the extended position so that the display 109 is visible. FIG. 3 also shows the divider 111. As divider 111, as used herein, is a physical boundary which separates the cab of the vehicle from the store box 102. The divider 111 can comprise a completely solid boundary, or, as depicted, the divider 111 can comprise a series horizontal and vertical bars which create a physical boundary. The mesh boundary, as depicted, allows the driver to see within the store. The divider 111 adds safety to the driver by preventing objects in the store box 102 from becoming dislodged during travel and injuring the driver. The divider 111 also acts to secure the contents of the store box 102. Thus, in one embodiment the divider 111 acts as an additional measure to lock the store box 102. Even if someone breaks into the vehicle, for example, if the divider 111 is locked, then that person would not have access to the store.

As shown, the cab also has access to a safe 112. The safe 112 can comprise any secure location which can hold valuable items such as money, and other items necessary in the operation of the store. The safe 112 can comprise any safe or storage equipment known in the art and can include locks, and keypads to increase security.

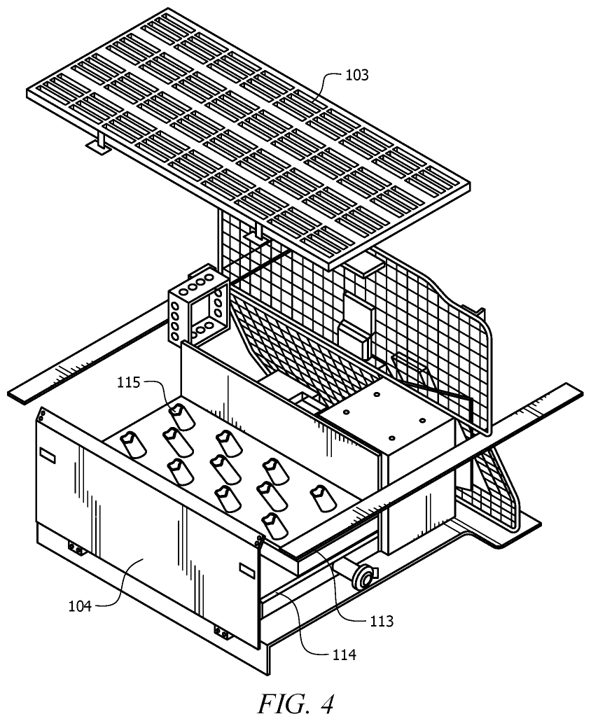

FIG. 4 is a rear perspective view of a store box in one embodiment. As shown the vehicle comprises a tail gate 104. This is for illustrative purposes only and should not be deemed limiting as the store box 102 can be used on vehicles 101 which do not have a tailgate.

In this embodiment, the rear side 105 is first rotated about the hinge 110 to reveal the tailgate 104. Thereafter, the tail gate 104 is either lifted downward or rotated to allow access to the central portion of the store box 102.

The interior of the store box 102 can be set up in a plurality of ways depending upon the products or services being sold. The interior of the store box 102 can house product for sale, display, etc. It can also house monitors, computers, etc. to allow customers to try, hold, and play with the inventory. The interior can house virtually any item currently found in traditional brick and mortar stores including cash register, inventory, etc. There are countless possibilities for the layout of the interior depending upon the product or services being sold.

In one embodiment the store box 102 comprises Bluetooth and/or Wifi, if necessary, to allow customers to experience the product and/or services. The store box 102 may further comprise registers and other equipment.

As depicted, the interior comprises two shelves—a top shelf 113 and a bottom shelf 114. In one embodiment, these shelves are slideably related such that the top shelf 113 rolls on or above the bottom shelf 114. This and other capabilities increase the surface area available within the interior of the store box 102. Thus, in one embodiment, once the tailgate 104 has been opened, the shelves extend and allow consumers access to the interior of the store box.

The cover 108 and/or the cover frame 116 can be raised or lowered via different mechanisms and devices as discussed. In some embodiments one or more cover frames 116 can be raised or lowered manually, whereas in other embodiments the covers 109 are automated to slideably move from an extended to a retracted position. FIG. 5 is a perspective view of a cover frame in one embodiment which illustrates one embodiment of accomplishing this movement.

FIG. 5 shows the cover frame 116. The cover frame 116 adds support and structure to the cover 108. Thus, a skin or cover layer would lay over the cover frame 116.

In one embodiment the cover frame 116 has a plurality of couplers 118 which engage with a threaded bolt 117 to raise and lower the frame 116. The couplers 118 are attached and secured to the cover frame 116 and they are threadingly engaged with a threaded bolt 117. In one embodiment they are threadingly engaged such that when the bolt 117 is rotated, the couplers 118 rise or lower depending upon the direction of rotation. In this manner, the frame 116, and accordingly the cover 108 can be raised and lowered.

In one embodiment the bolt 117 is coupled to a sprocket, gear, or other drive mechanism which can be coupled to a chain, belt, etc. which is attached to a motor. When the motor is initiated, the belt or chain is rotated which causes the sprocket, as an example, to rotate. This cause the bolt 117 to likewise rotate which raises or lowers the cover 108.

In one embodiment each cover 108 is associated with an independent motor so that the cover 108 can be raised and lowered independently. In other embodiments, however, a single motor raises and lowers more than one cover 108. In one embodiment the system further comprises a clutch which engages and disengages with a specified coupler. In this fashion, a single motor can be used to raise and lower multiple covers 108 independently by selectively determining which sprocket, for example, to engage.

FIG. 6 is a perspective view of a coupler in one embodiment. In one embodiment, one or more couplers 118 will be attached at least to the frame 116. In one embodiment a coupler 118 is attached to each corner of the frame 116. Thus, in that embodiment there are four couplers 118 per frame 116.

The couplers 118 both couple to the frame/cover as well as engage with the threaded bolt 117. As shown the couplers comprise adapters 120 which are used to attach to the frame 116. As shown the adapters 120 comprise screws which are used to attach to the frame, although any adapting and coupling mechanism can be utilized.

The coupler 118 also comprises a connector 119 which engages with the threaded bolt 117. In one embodiment the connector 119 comprises threads which match with the threaded bolt 117. In this fashion, as noted, when the threaded bolt 117 is rotated, the connector 119 will raise or lower accordingly.

Having a single device such as a coupler 118 which can connect both the cover/frame and the threaded bolt is an advantage because it simplifies installation, assembly, and operation. A single device connects the driver and the cover eliminating unnecessary parts.

While an embodiment has been described in reference to a threaded bolt 117 which provides the mechanism for raising and lowering the covers 108, this is for illustrative purposes only and should not be deemed limiting. Other mechanisms which provide for movement can also be utilized including, but not limited to, hydraulic and pneumatic systems.

One example of a mechanical solution to raising and lowering the cover is illustrated with FIG. 7. FIG. 7 is a side view of a counterbalance in one embodiment. A counterbalance, as used herein, refers to a rope, cable, chord, string, wire ribbon, etc. which attaches to the cover 108 or cover frame 116 and allows for a safer, smoother, raising and lowering. In one embodiment, a counterbalance works similar to the cable and spring system used for garage doors. The weight of a garage door can be significant. Without the cable and spring system, it is very difficult to raise and lower a garage door. In one embodiment, the system uses a counterbalance to provide for a smooth, safe, and easier raising and lowering of the cover 108.

FIG. 7 shows the counterbalance 122 attaching to the cover frame 116. As noted, the counterbalance 122 can attach to the cover 108, the front sign, the cover frame 116, etc. Virtually any object which can be raised and lowered can be coupled to a counterbalance 122.

The counterbalance 122 couples to the desired object, here the cover frame 116, and a housing 125. The housing 125 secures the opposite end of the counterbalance 122 to an object such as the box frame 124. The housing 125 secures undeployed counterbalance 122. If the cover frame 116 depicted were lowered vertically downward, additional counterbalance 122 would be deployed from the housing 125.

In one embodiment, the counterbalance 122 is further coupled to a spring 123 which creates additional tension. The spring 123 helps offset the weight of the cover frame 116. This assists the user in opening the cover frame 116 by requiring less force. Furthermore, the spring 123 can resist fast deployment which softens the closing of the cover frame 116. One skilled in the art will understand the various spring 123 tensions and strength which will aid the user in raising and lowering the cover frame 116.

In one embodiment the counterbalance 122 comprises metal ribbon. The metal ribbon, in one embodiment, is a spring itself. It provides tension to aid the user in raising and lowering the cover frame 116.

It should be noted that while the extended and retracted positions show the cover moving laterally, this is for illustrative purposes and should not be deemed limiting. The cover 108 moves to allow the display and or underlying contents to be shown. The cover can move in any fashion which accomplishes this goal.

The system described herein has several benefits. First, as noted, the system allows for transformation between a display and travel position. Because the covers 108 offer protection to the interior of the store box 102, the store box 102 is mobile. This allows the mobile store 100 to reach customers directly. While consumers are buying more product on-line, there are many products which consumers desire to hold and experience prior to making a purchase. The mobile store 100 allows a retailer to travel to the customer and allow the customer, who may otherwise purchase online, an opportunity to experience the product or service firsthand.

The mobile store 100 can travel directly to customers and can focus on locations with a large customer base. As an example, the mobile store 100 can travel to sports events. Often over 100,000 people attend a football game. The mobile store 100 can be situated near the stadium, for example, giving these 100,000 potential customers an opportunity to experience the product or service firsthand.

Another advantage is that the mobile store 100 is nimble. Because, in some embodiments, the mobile store 100 is located on a traditional vehicle, such as Jeep, the mobile store 100 does not require a large footprint in which to operate. Put differently, because the mobile store 100 is not on a large trailer, it does not require significant square footage. Rather, the mobile store 100 can set up and operate in virtually any parking spot. It can park and operate in a driveway, walkway, or virtually anywhere a Jeep can park. This allows the mobile store 100 to be specifically situated in ideal locations.

Another advantage is the ability to quickly transition between travel and display positions. As noted, in one embodiment the covers and or hinge are automated. This allows the operator to park the mobile store 100, and quickly open the store for business. Often this simply requires the press of a button. In very short order, the covers 108 are put in their extended position such that the display 109 or underlying inventory is revealed. Thereafter, as quickly as it extended, the covers 108 can retract to their travel positions and the mobile store 100 is mobile again.

While the invention has been particularly shown and described with reference to a preferred embodiment, it will be understood by those skilled in the art that various changes in form and detail may be made therein without departing from the spirit and scope of the invention.

What is claimed is:

1. A system comprising:
a store box, wherein said store box comprises at least one cover moveable between a retracted and extended position, wherein said cover is adjacent to a display when in said retracted position;
wherein said store box comprises an interior void.

2. The system of claim 1 wherein said store box comprises four sides and a top.

3. The system of claim 1 wherein said store box comprises at least three displays.

4. The system of claim 1 wherein said cover is automated move between a retracted and extended position.

5. The system of claim 1 wherein said store box comprise a rear side, and wherein said rear side is connected via a hinge, and wherein said rear side pivots about said hinge.

6. The system of claim 1 wherein said internal void comprises at least one extendable shelf.

7. The system of claim 1 wherein said at least one cover comprises a frame, and wherein said frame is coupled to a motor to raise and lower said frame.

8. The system of 7 further comprising a coupler which couples to said frame, wherein said coupler comprises a connector which couples to a bolt, and wherein rotation of said bolt raises and lowers said frame.

9. The system of claim 1 further comprising a frame, and wherein said frame is coupled to a counterbalance.

10. The system of claim 9 wherein said counterbalance is coupled to a spring.

11. The system of claim 9 wherein said counterbalance comprises metal ribbon.

12. The system of claim 9 wherein said counterbalance comprises a spring.

13. The system of claim 1 further comprising a vehicle coupled to said store box.

14. The system of claim 12 wherein said vehicle comprises a tail gate which can open to allow access to said interior void.

15. The system of claim 12 further comprising a divider which separates said vehicle from said box store.

16. The system of claim 1 further comprising a lock to lock said at least one cover.
